(19) United States
(12) Patent Application Publication
(10) Pub. No.: US 2016/0209015 A1
(43) Pub. Date: Jul. 21, 2016

(54) COLLAPSIBLE WORKLIGHT ASSEMBLY

(71) Applicants: RICHARD RUSSELL MUMMA, ROANOKE, TX (US); GARY VAN DEURSEN, ESSEX, CT (US); JOHN KILLMEYER, ALLEN, TX (US); ERIC S. SATTERTHWAITE, WILLARD, UT (US); WILLIAM POLLARD, DENTON, TX (US); DREW AVINGER, FLOWER MOUND, TX (US)

(72) Inventors: RICHARD RUSSELL MUMMA, ROANOKE, TX (US); GARY VAN DEURSEN, ESSEX, CT (US); JOHN KILLMEYER, ALLEN, TX (US); ERIC S. SATTERTHWAITE, WILLARD, UT (US); WILLIAM POLLARD, DENTON, TX (US); DREW AVINGER, FLOWER MOUND, TX (US)

(21) Appl. No.: 15/055,397

(22) Filed: Feb. 26, 2016

Related U.S. Application Data
(63) Continuation-in-part of application No. 14/775,061, filed on Sep. 11, 2015, now Pat. No. 9,316,384.
(60) Provisional application No. 61/777,085, filed on Mar. 12, 2013.

(51) Int. Cl. F21V 21/30; F21L 14/00; F21V 21/14

(52) U.S. Cl. CPC F21V 21/30; F21V 21/145; F21L 14/00; F21W 2131/1005

(57) ABSTRACT

A collapsible worklight assembly comprises a head assembly and a multi-legged support assembly. The head assembly includes first and second worklights hingedly attached to each other, allowing the head assembly to be open in a deployed configuration and closed in a collapsed configuration. The head assembly is hingedly attached to the multi-legged support assembly. The multi-legged support assembly includes a support head and a plurality of support legs. The support head includes a hinged connection to the head assembly that allows the plurality of support legs to rotate towards the head assembly in a collapsed configuration and away from the head assembly in a deployed configuration.

### CROSS REFERENCE TO RELATED APPLICATIONS

This application is a continuation-in-part of U.S. application Ser. No. 14/775,601, filed 11 Sep. 2015, titled “Collapsible Worklight Assembly,” which is a 371 of international P.C.T. Application No. PCT/US2014/024638 filed 12 Mar. 2014, titled “Collapsible Worklight Assembly,” which claims the benefit of U.S. Provisional Application No. 61/777,085, filed 12 Mar. 2013, titled “Collapsible Worklight Assembly,” all of which are hereby incorporated by reference for all purposes as if fully set forth herein.

### BACKGROUND

1. Field of the Invention

The present disclosure relates to portable worklights and stands, particularly portable worklights that can be supported by a multi-legged support structure.

2. Description of Related Art

Portable worklights are known that can be supported by a multi-legged support structure. Such worklights are commonly used wherever portable light sources may be needed, such as on temporary work sites. However, such worklights and support structures typically include a number of parts that must be assembled and disassembled when the worklight is moved from one location to another. Such construction also makes it necessary to have an additional case or box to store the various pieces whenever the worklight is in transport or storage.

For example, U.S. Pat. No. 5,964,524 to Qian discloses a worklight and stand having a multi-legged support and a main pole consisting of three segments. Qian discloses that the worklight and stand can be broken into several pieces and stored within a separate container.

While there are advantages to such worklights and stands, such as providing a portable light source, such worklights and stands are subject to time-consuming setup and teardown and are susceptible to loss of parts, especially on job sites where the worklight might be torn down or set up under limited light conditions or other conditions where parts can easily be misplaced. Thus, there exists significant room for improvement in the art for overcoming these and other shortcomings of conventional systems for collapsible worklight assemblies.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 shows a perspective view of a worklight assembly according to the present disclosure in a deployed configuration;

FIG. 2 shows a perspective view of the worklight assembly shown in FIG. 1, but in a collapsed configuration;

FIG. 3 shows a side view of the collapsed worklight assembly shown in FIG. 2;

FIG. 4 shows a bottom view of the collapsed worklight assembly shown in FIG. 2;

FIG. 5 shows a top view of the collapsed worklight assembly shown in FIG. 2;

FIG. 6 shows a front view of a portion of the deployed worklight assembly shown in FIG. 1;

FIGS. 7A and 7B show perspective views of an expansion pack being attached to the worklight assembly shown in FIG. 1;

FIG. 8 shows a perspective view of a worklight assembly according to the present disclosure in a deployed configuration;

FIG. 9 shows a front view of a worklight assembly according to the present disclosure in a deployed configuration;

FIG. 10 shows a top view of a worklight assembly according to the present disclosure in a deployed configuration;

FIG. 11 shows a side view of a worklight assembly according to the present disclosure in a deployed configuration;

FIG. 12 shows a perspective view of a head assembly according to the present disclosure in a deployed configuration;

FIG. 13 shows a perspective view of a head assembly according to the present disclosure in a deployed configuration;

FIG. 14 shows a back view of a head assembly according to the present disclosure in a deployed configuration;

FIG. 15 shows a top view of a head assembly according to the present disclosure in a deployed configuration;

FIG. 16 shows a front view of a head assembly according to the present disclosure in a deployed configuration;

FIG. 17 shows a perspective view of a support head assembly according to the present disclosure in a deployed configuration;

FIG. 18 shows a side view of a support head assembly according to the present disclosure in a deployed configuration;

FIG. 19 shows a front view of a support head assembly according to the present disclosure in a deployed configuration;

FIG. 20 shows a top view of a quick release member assembly according to the present disclosure in a locked configuration;

FIG. 21 shows a top view of a quick release member assembly according to the present disclosure in a rotatable configuration;

FIG. 22 shows a top view of a quick release member assembly according to the present disclosure in a removable configuration;

FIG. 23 shows a top view of a mast base according to the present disclosure in a non-rotated configuration;

FIG. 24 shows a top view of a mast base according to the present disclosure in a partially rotated configuration;

FIG. 25 shows a perspective view of the worklight assembly shown in FIG. 8, but in a collapsed configuration;

FIG. 26 shows a perspective view of the worklight assembly shown in FIG. 8, but in a collapsed configuration;

FIG. 27 shows a side view of the worklight assembly shown in FIG. 8, but in a collapsed configuration;

FIG. 28 shows a top view of the worklight assembly shown in FIG. 8, but in a collapsed configuration;

FIG. 29 shows a front view of the worklight assembly shown in FIG. 8, but in a collapsed configuration;

FIG. 30 shows a perspective view of a locked worklight assembly according to the present disclosure in a deployed configuration;

FIG. 31 shows a partial expanded perspective view of the worklight assembly shown in FIG. 30; and

FIG. 32 shows a back view of an installed battery for a worklight assembly.

While the assembly and method of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the extruded aluminum canopy with hidden fasteners system and method are provided below. It will of course be appreciated that in the development of any actual embodiment, numerous implementation-specific decisions will be made to achieve the developer's specific goals, such as compliance with assembly-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present disclosure provides an improved portable worklight assembly that includes a collapsible support structure that can easily be deployed and collapsed without the need for assembly/disassembly of multiple parts or for a separate storage container.

According to some aspects of the present disclosure, a collapsible worklight assembly comprises a head assembly and a multi-legged support assembly. The head assembly includes a first worklight and a second worklight hingedly attached to the first worklight. The multi-legged support assembly includes a support head and a plurality of support legs connected to the support head. The multi-legged support assembly is hingedly attached to the head assembly via the support head. The head assembly can include a tension knob for controlling the ease with which the multi-legged support assembly can be rotated relative to the head assembly. The plurality of legs can each include a respective plurality of leg segments. The legs can of fixed or adjustable length. Preferably, the legs are telescopically lengthwise adjustable.

The first and second worklights can be hingedly attached to each other so as to be rotatable relative to each other about a first axis, and the multi-legged support assembly can be hingedly attached to the head assembly such that the plurality of legs can be rotated relative to the head assembly about a second axis. In some embodiments, the first axis can be substantially orthogonal to the second axis. In some embodiments, the collapsible worklight assembly can further include a handle connected between the first and second worklights. The handle can be configured so that the longitudinal axis of the handle is at least somewhat parallel to the first axis. The first and second worklights can include respective first and second worklight housings, where the first worklight housing is connected to the handle via a first plurality of arms, and the second worklight housing is connected to the handle via a second plurality of arms.

The plurality of legs can be rotatable relative to the head assembly to a collapsed configuration. While in the collapsed configuration, a first support leg of the plurality of legs can be adjacent to the first worklight and a second support leg of the plurality of legs can be adjacent to the second worklight. The first support leg can be held adjacent to the first worklight by a first support-retaining member, and the second support leg can be held adjacent to the second worklight by a second support-retaining member.

The first and second worklights include respective first and second light panels. In some embodiments, the light panels can each include a plurality of light emitting diodes (LEDs) and/or other light sources. The first and second worklights can be hingedly attached to each other so as to be rotatable between a collapsed configuration and a deployed configuration, where the first and second light panels face each other in the collapsed configuration.

The first and second worklights can include respective power switches. Alternatively, the first and second worklights can be configured to be powered together via a single power switch.

The collapsible worklight assembly can further include one or more expansion packs. Each expansion pack includes one or more additional worklights that can be removably attached to the head assembly. For example, in some embodiments, an expansion pack can be somewhat identical to the head assembly. So in such embodiments, the expansion pack can include first and second worklight hingedly attached to each other.

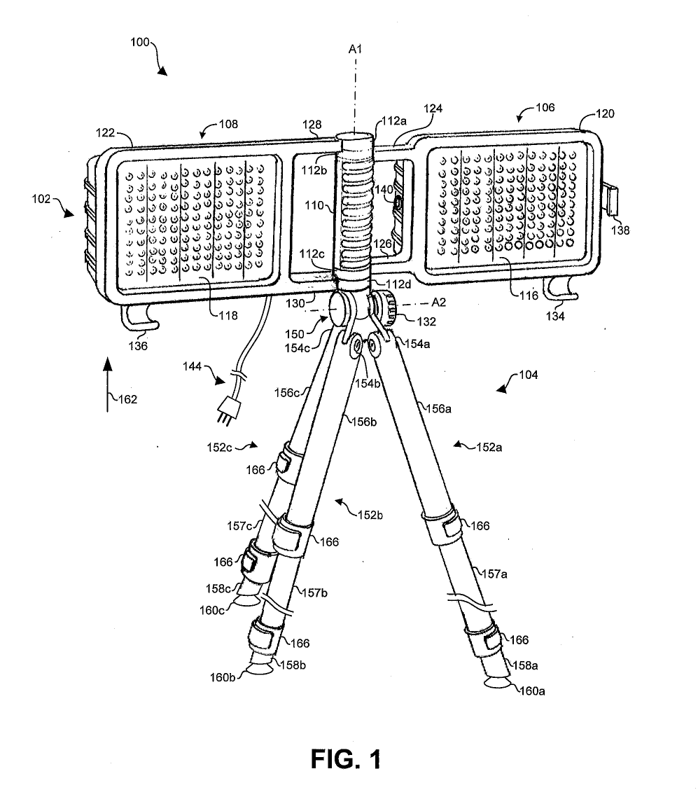

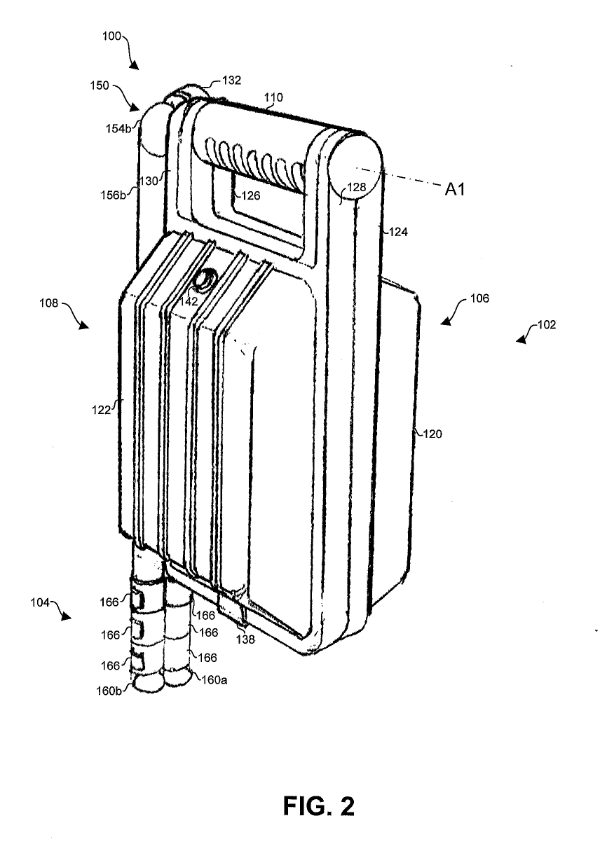

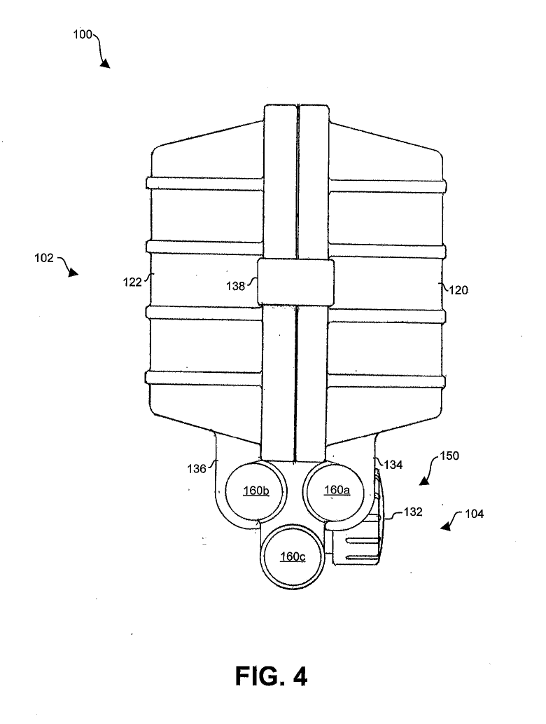

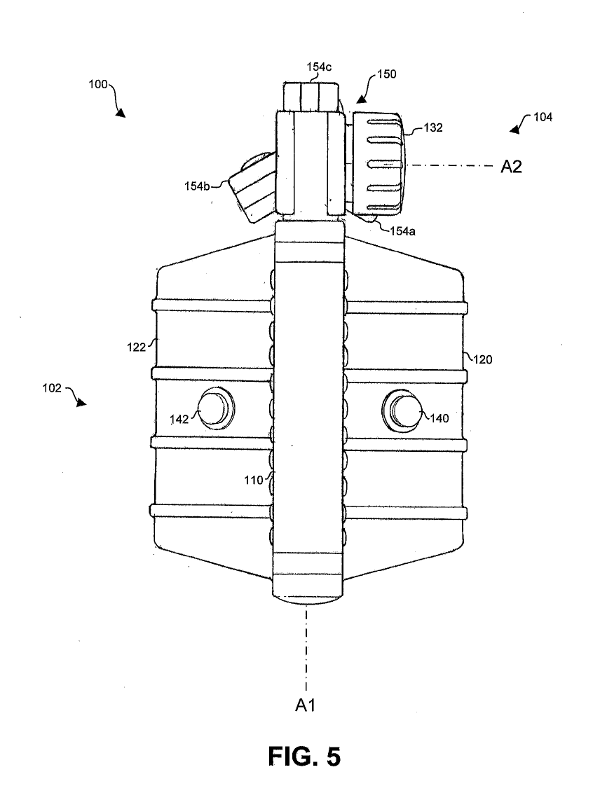

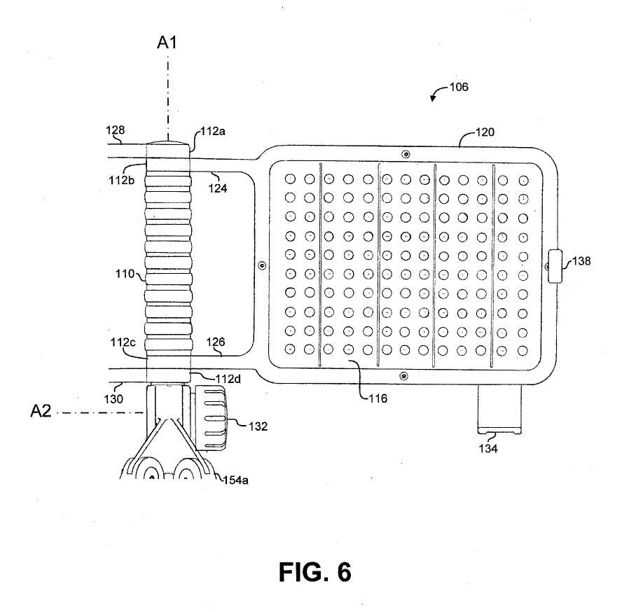

FIGS. 1-6 show an embodiment of a worklight assembly 100. FIGS. 1 and 6 show the worklight assembly 100 in a deployed state, whereas FIGS. 2-5 show the worklight assembly 100 in a collapsed state. The worklight assembly 100 includes a head assembly 102 connected to a multi-legged support assembly 104. In the deployed state, the head assembly 102 is supported by the multi-legged support assembly 104 so that the worklight assembly 100 can be used to illuminate an adjacent area. In the collapsed state, the head assembly 102 and multi-legged support assembly 104 are folded together so that the worklight assembly 100 can easily be transported or stored while not in use.

The head assembly 102 includes a first worklight 106 and a second worklight 108. The worklights 106 and 108 are both hingedly connected to a handle 110. The worklights 106 and 108 can be swiveled relative to the handle 110 by means of articulated joints 112a, 112b, 112c, and 112d. The articulated joints 112a-112d allow the worklights 106 and 108 to move between the deployed configuration shown in FIGS. 1 and 6, and the collapsed configuration shown in FIGS. 2-5. More specifically, the worklights 106 and 108 are configured to rotate relative to each other about a longitudinal axis A1 of the handle 110. In the view shown in FIG. 1, the worklights 106 and 108 have been rotated 180 degrees about axis A1 from the collapsed configuration shown in FIG. 2. In some embodiments, 180 degrees can be the maximum open angle such that the configuration shown in FIG. 1 would be a fully-opened state. However, alternative embodiments can be configured for other maximum angles, including angles greater than and less than 180 degrees.

Worklights 106 and 108 each include a respective one of light panels 116 and 118. In the preferred embodiment, the light panels 116 and 118 each include a plurality of LEDs, however other light sources can be used. The light panels 116 and 118 can be substantially identical to each other, for example both including the same number of LEDs arranged in the same pattern, or the light panels 116 and 118 can differ from each other, for example one having more LEDs than the other. The exact number, arrangement, and types of LEDs can vary. In one embodiment, for example, light panels 116 and 118 can be configured to emit about 6,000 Lumens each so that the light panels 116 and 118 together can emit about 12,000 Lumens. However, alternative embodiments can be configured to emit any of a great variety of different Lumen values. Also, in some embodiments, the worklights 106 and 108 can include multiple brightness settings. For example, worklights 106 and 108 can include a “HIGH” setting and a “LOW” setting, where more lumens are emitted in the “HIGH” setting than in the “LOW” setting. In one such embodiment, as an example, light panels 116 and 118 can be configured to emit about 6,000 Lumens each in the “HIGH” setting and about 3,000 Lumens each in the “LOW” setting.

In some embodiments, the worklights 106 and 108 can be configured to be independently turned on and off, for example so that a user can turn on/off only one or both of the worklights 106 and 108 if so desired. For example, in the illustrated embodiment, each of the worklights 106 and 108 includes a respective one of power switches 140 and 142. Alternatively, the worklights 106 and 108 can be controlled to only be turned on and off together, for example from a single power switch.

The worklights 106 and 108 can be battery-powered, solar-powered, and/or include means for receiving electrical power from an outside power source. For example, one or both of the worklights 106 and 108 can include a power cord 144.

The light panels 116 and 118 are supported by respective worklight housings 120 and 122. The worklight housings 120 and 122 are preferably formed of a durable rigid material, such as a plastic or metal material.

The worklight housing 120 includes an upper arm 124 and a lower arm 126 for connecting the worklight housing 120 to the articulated joints 112b and 112c, respectively. The worklight housing 122 includes an upper arm 128 and a lower arm 130 for connecting the worklight housing 122 to the articulated joints 112a and 112d, respectively. The arms 124, 126, 128, and 130 also serve to distance the worklight housings 120 and 122 from the handle 110 so that a user can easily grip the handle 110 when the worklight assembly 100 is in the collapsed configuration.

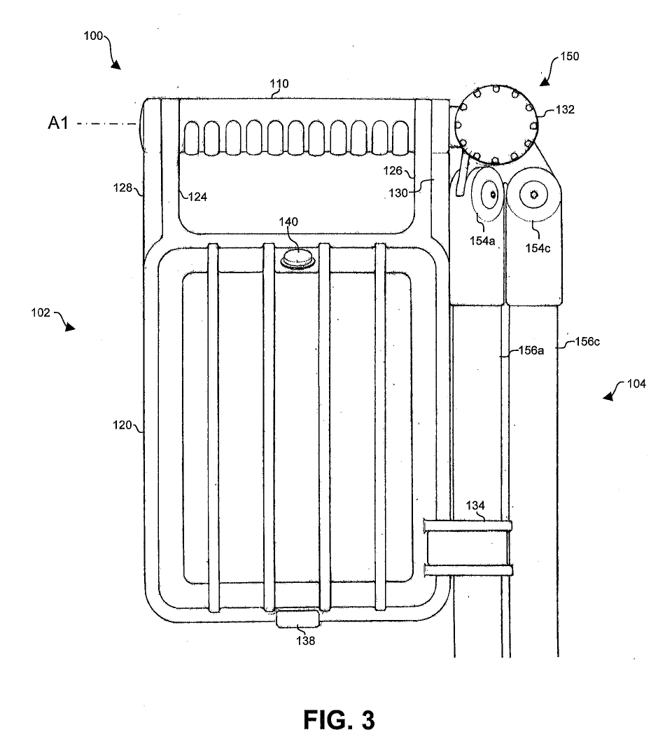

The worklight housings 120 and 122 also include respective support-retaining members 134 and 136. Referring to FIG. 3, the support-retaining members 134 and 136 help to secure the multi-legged support assembly 104 relative to the head assembly 102 while the worklight assembly 100 is in the collapsed configuration.

The worklight housing 120 also includes a spring latch 138. Referring to FIG. 3, the spring latch 138 helps to secure the worklight housing 120 and the worklight housing 122 together in the collapsed configuration. The spring latch 138 can be operated by a user to release the worklight housing 122 from the worklight housing 120 in order to deploy the worklight assembly 100.

The head assembly 102 is connected to the multi-legged support assembly 104 via a support head 150 of the multi-legged support assembly 104. The support head 150 includes a tension knob 132 that can be loosened to allow the head assembly 102 to rotate about axis A2 relative to the multi-legged support assembly 104. The tension knob 132 can also be tightened to hold the head assembly 102 in place relative to the multi-legged support assembly 104.

In the illustrated embodiment, the multi-legged support assembly 104 is a tripod, however the multi-legged support assembly 104 can have another number of support legs in alternative embodiments. The multi-legged support assembly 104 comprises a support head 150 and three support legs 152a-152c that are configured so as to be identical and connected to the support head 150 by means of respective articulated joints 154a-154c. The support legs 152a-152c can be swiveled relative to the support head 150 within an angular range by means of the articulated joints 154a-154c. The tripod legs 152a-152c each include a respective upper leg section 156a-156c, a respective middle leg section 157a-157c, and a respective lower leg section 158a-158c. Upper leg sections 156a-156c are each connected to a respective one of the articulated joints 154a-154c, and lower leg sections 158a-158c are each connected to a respective one of the support feet 160a-160c.

The maximum height of the multi-legged support assembly 104 in the height direction 162 is dependent on the length and on the standing position of the support legs 152a-152c. In order to extend the height range of the multi-legged support assembly 104, the support legs 152a-152c include respective leg sections 156a-158c, 156b-158b, and 156c-158c that can be slid telescopically relative to each other (e.g., lower leg section 158a can slide in and out of middle leg section 157a, and middle leg section can slide in and out of upper leg section 156a). The leg sections 156-158 can be clamped to prevent the telescopic sliding with respect to each other by means of clamping mechanisms 166 that are configured in the form of a clamping lever. The support legs 152a-152c can be collapsed by releasing the clamping mechanisms 166 and sliding the respective lower leg sections 158a-158c into respective middle leg sections 157a-157c, and sliding the respective middle leg sections 157a-157c into the respective upper leg sections 158a-158c.

The worklight assembly 100 can be collapsed (e.g., from the deployed configuration shown in FIG. 1) by collapsing the support legs 152a-152c, then swiveling the support legs 152a-152c towards each other relative to the support head 150 by means of the articulated joints 154a-154c, then loosening the tension knob 132 and rotating the multi-legged support assembly 104 about axis A2 such that two of the support legs 152 are somewhat aligned with support-retaining members 134 and 136, then closing the head assembly 102 (folding worklights 106 and 108 towards each other about axis A1) so as to retain two of the support legs 152 in place with the support-retaining members 134 and 136. Also, the head assembly 102 can be closed and held closed by latch 138. The process can be reversed in order to deploy the worklight assembly 100.

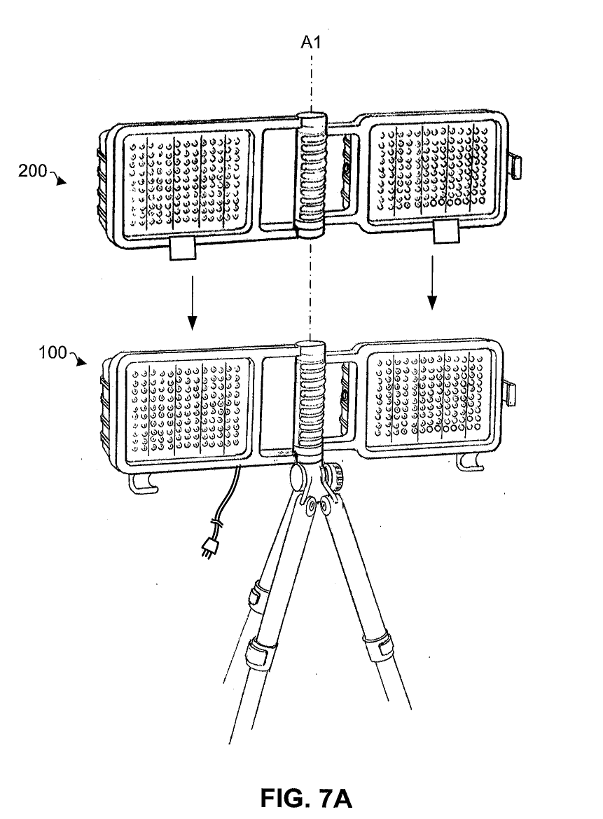

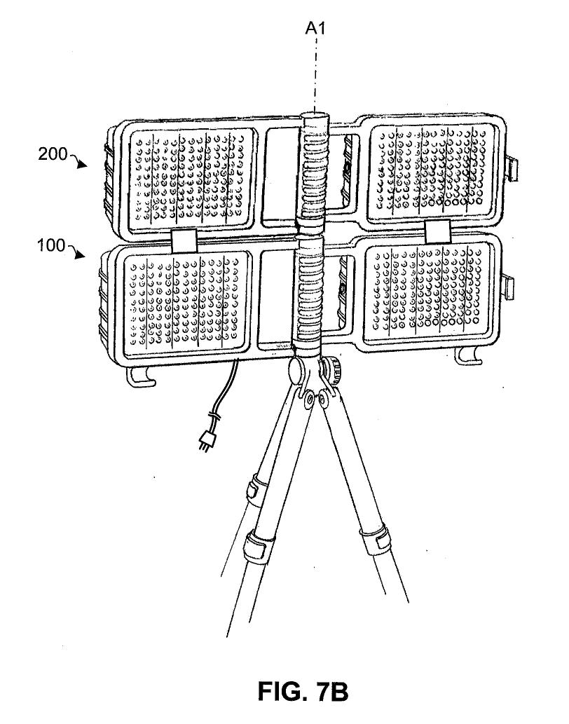

Referring next to FIGS. 7A and 7B, an expansion pack 200 can be included with the worklight assembly 100 for providing additional light when desired. The expansion pack 200 can be substantially the same as the head assembly 102, except that the expansion pack 200 can be removably attached to the top of the head assembly 102. So, for example, the expansion pack 200 can be collapsed and deployed in the same way as described above for the head assembly 102. While only one expansion pack 200 is shown, in some embodiments two or more such expansion packs 200 can be provided for allowing for still higher illumination levels.

FIGS. 7A and 7B show how the expansion pack 200 can be mechanically attached to the top of the head assembly 102 through the use of one or more clamps 202. In some embodiments, the expansion pack 200 can also be electrically connected to the head assembly 102 so that the expansion pack 200 can be turned on and off with the work lights 106 and 108.

A worklight assembly that can be compactly stored and easily unfolded provides advantages to those that need light quickly and remotely. The worklight assembly must be stable such that the worklight cannot easily tip over. Furthermore, worklight assembly can be mounted directly to a vehicle, such as a fire truck with a vehicle mount. Worklight assembly preferably includes three folding legs that are hingedly attached to a base. Folding legs are preferably lockable to prevent the inadvertent folding of the assembly. Locking mechanism is preferably a spring biased rotational member with a plurality of radially spaced fingers that prevent the legs from rotating up. Locking mechanism can be bypassed by rotating rotational member relative to the base so the fingers do not prevent the legs from rotating up towards a mast.

Mast is comprised of various nesting members, typically three members, to provide an adjustable height for the worklight assembly. A lowest portion of the mast is rigidly attached to the base. A support head is rotationally coupled to a upper member of the mast. A locking mechanism near the top of the mast provides adjustability to the support head. Locking mechanism is configured to prevent the rotation of a lower member of the support head. Locking mechanism is also configured to allow the rotation of a lower member, along an axis of the mast, of the support head. Locking mechanism is configured to release a lower member of the support head. A user by moving a handle of the locking mechanism can prevent rotation of the support head, allow rotation of the support head, and release the lower member of the support head.

Support head is configured to allow a user to rotate light panels of the worklight assembly, forwardly and backwardly, towards the ground or away from the ground. Support head is adjustable and is comprised of the lower member, an upper member, and a handle. Support head is geared to prevent movement between the base and the upper member. A user can squeeze the handle, which separates the gears, and allows for rotation between the upper member and the lower member. Release of the handle compresses the gears together and prevents rotation.

A head assembly sits upon the support head and is configured to be unfolded and provide work lighting as needed. Head assembly is comprised of a handle hingedly coupled to a first light panel and hingedly coupled to a second light panel. Preferably the first light panel and the second light panel are identical units. The first light panel and the second light panel open similar to a book where the light panels are pages and the handle is the binding. This configuration allows a flat faced worklight. Because the first light panel is identical to the second light panel various parts between them are interchangeable. In order to keep the light panels closed, a rubber latch is mounted to a stud on one light panel and grabs a similarly placed stud on the second light panel.

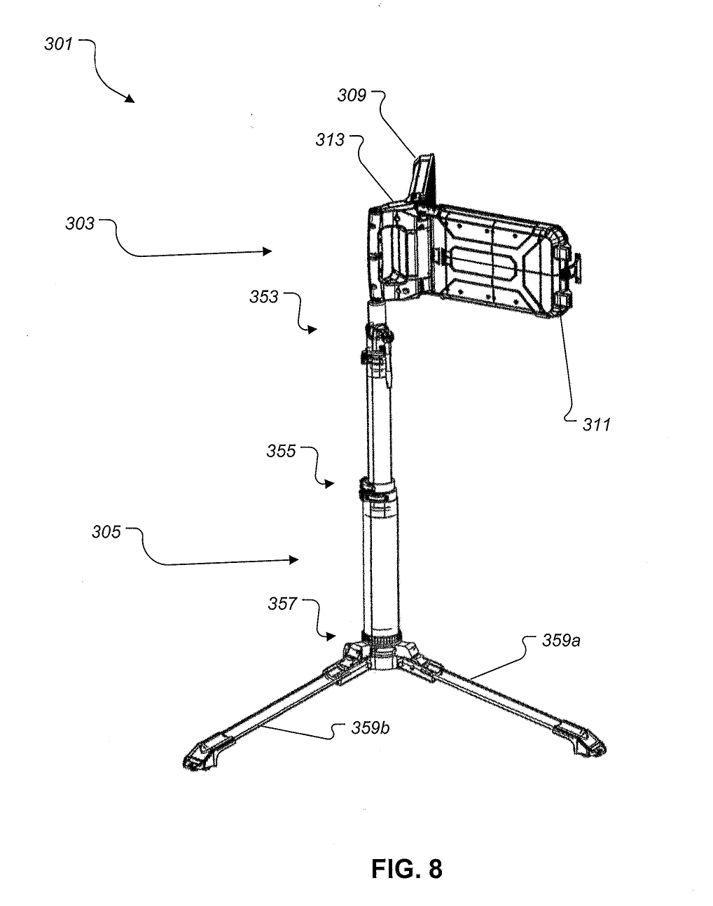

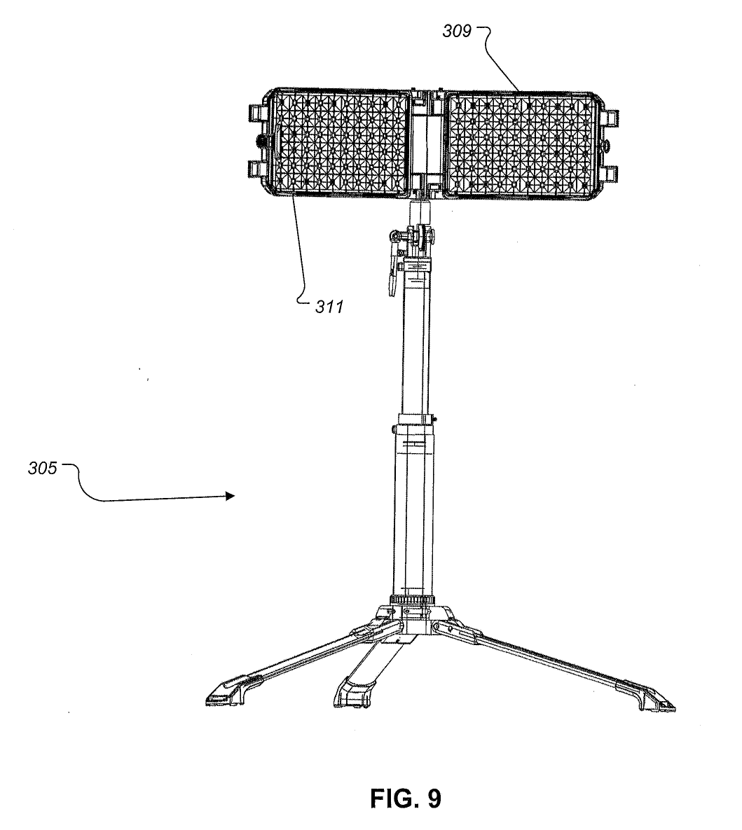

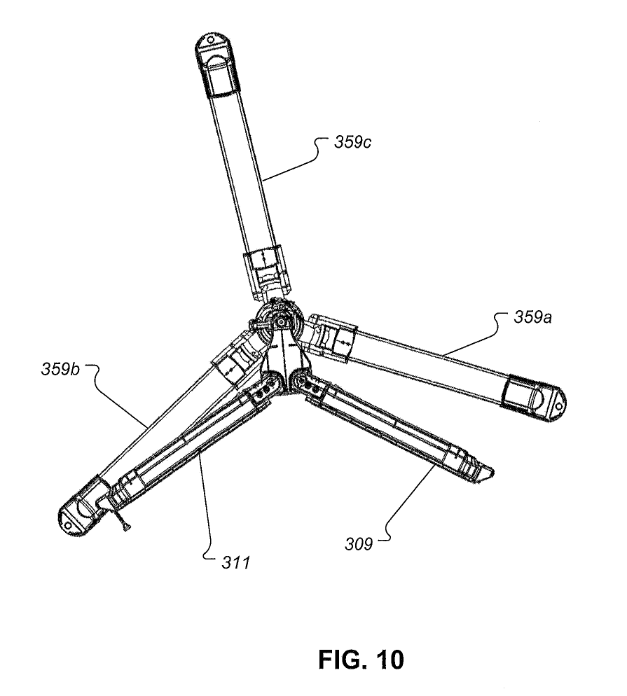

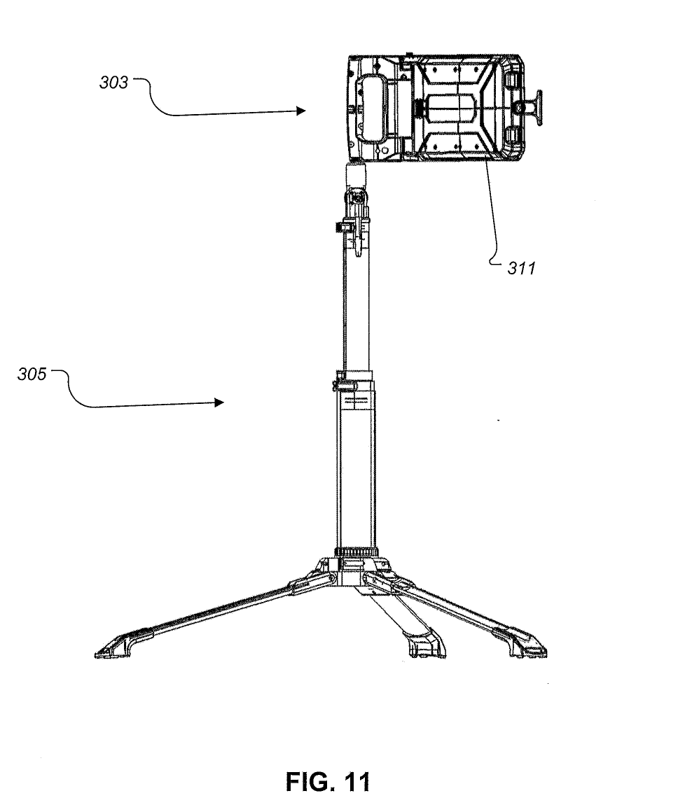

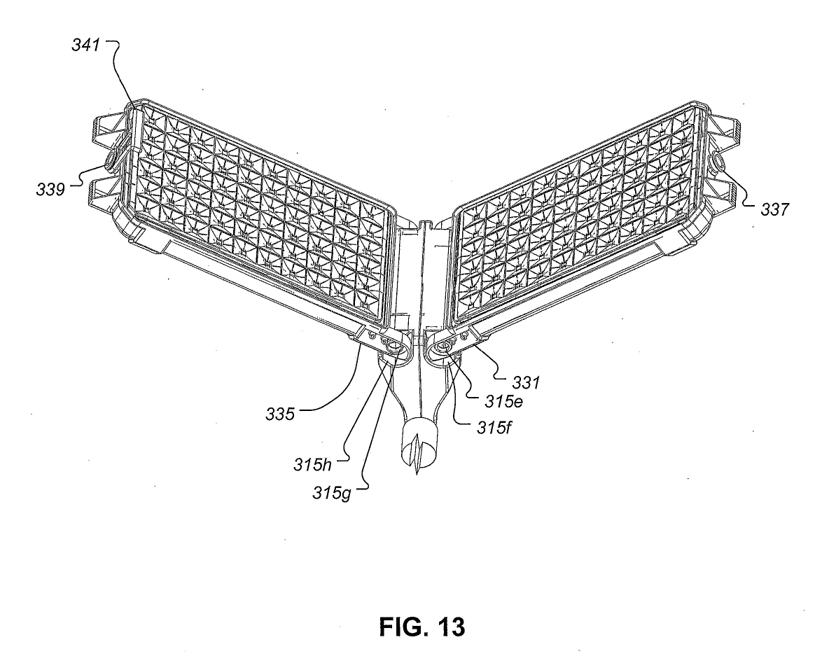

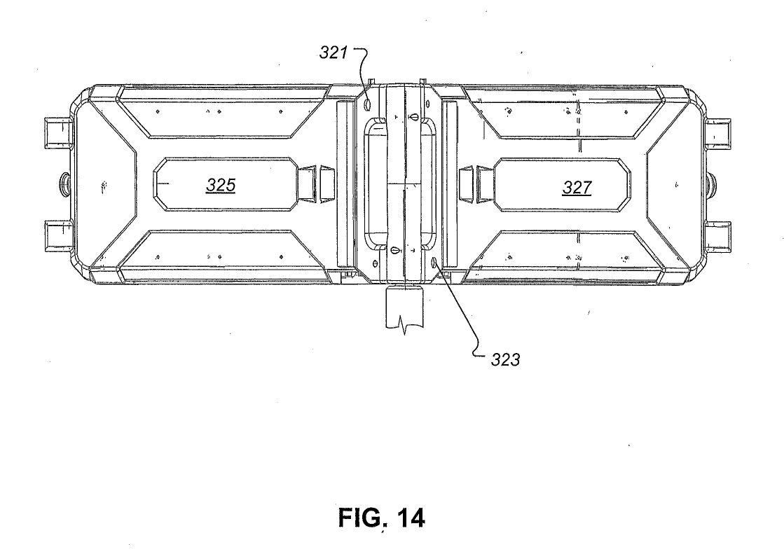

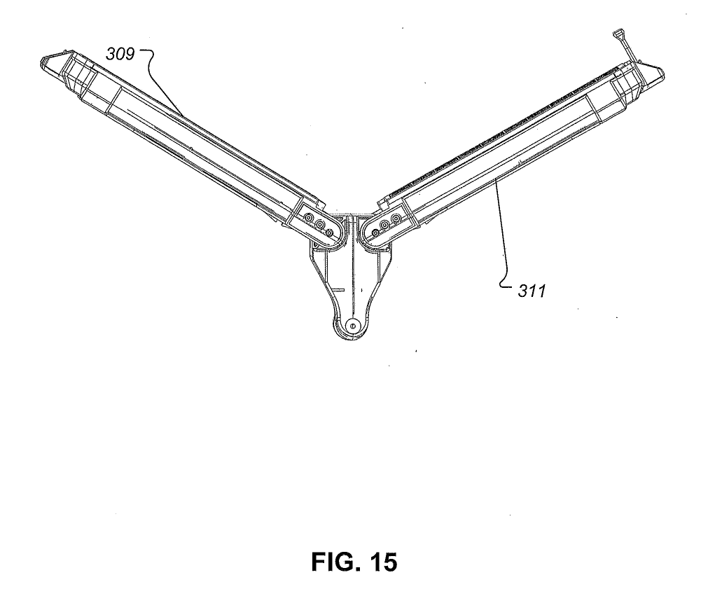

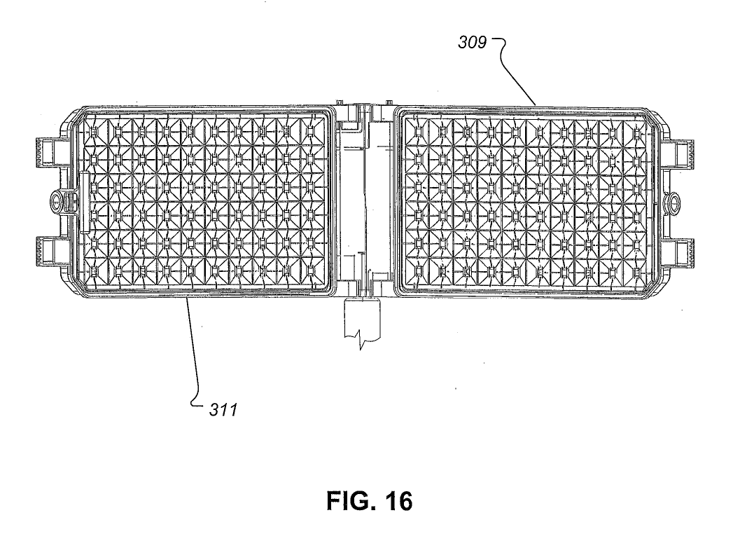

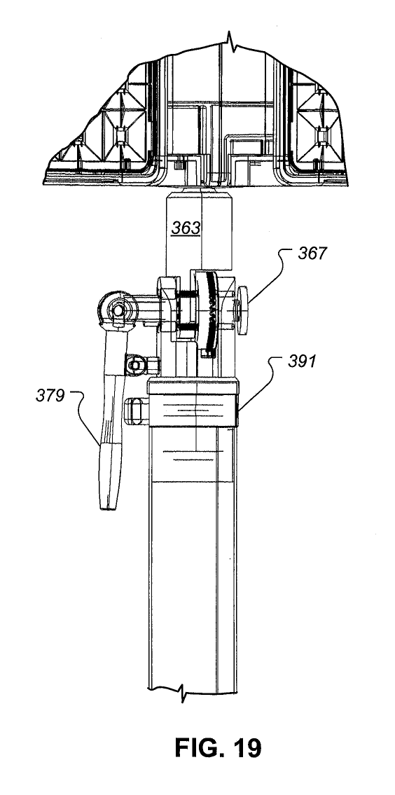

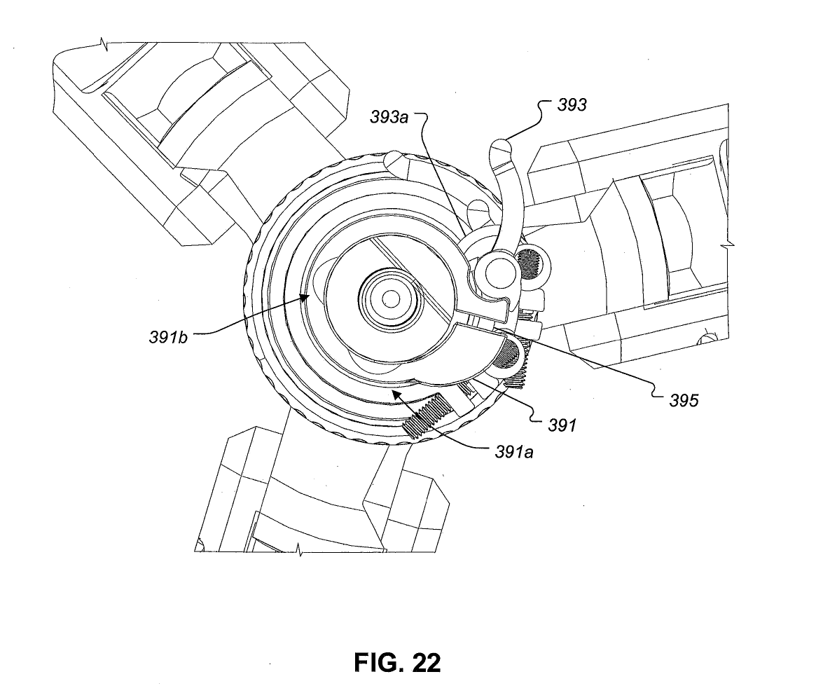

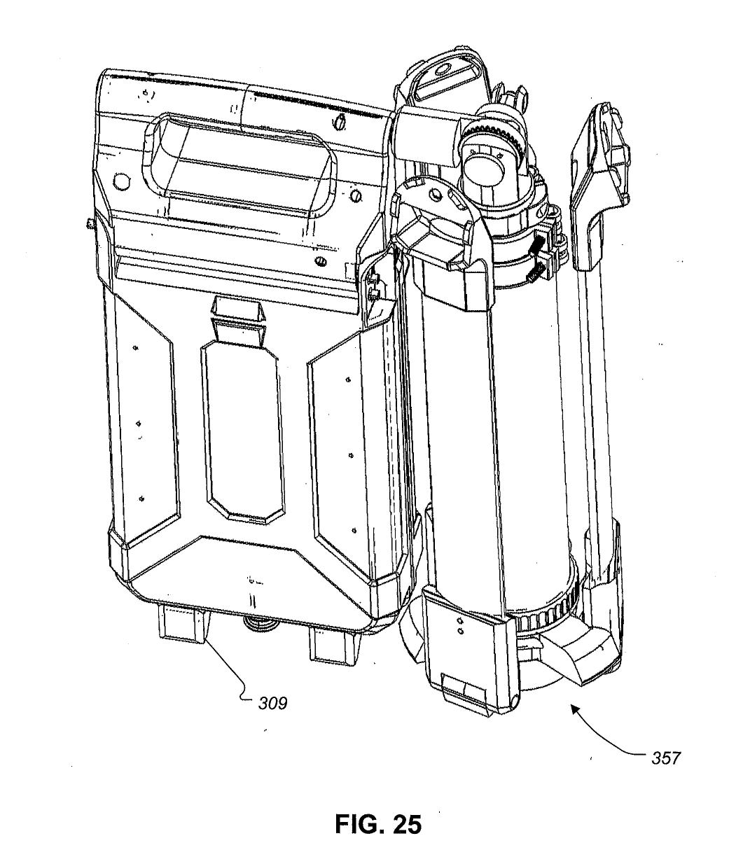

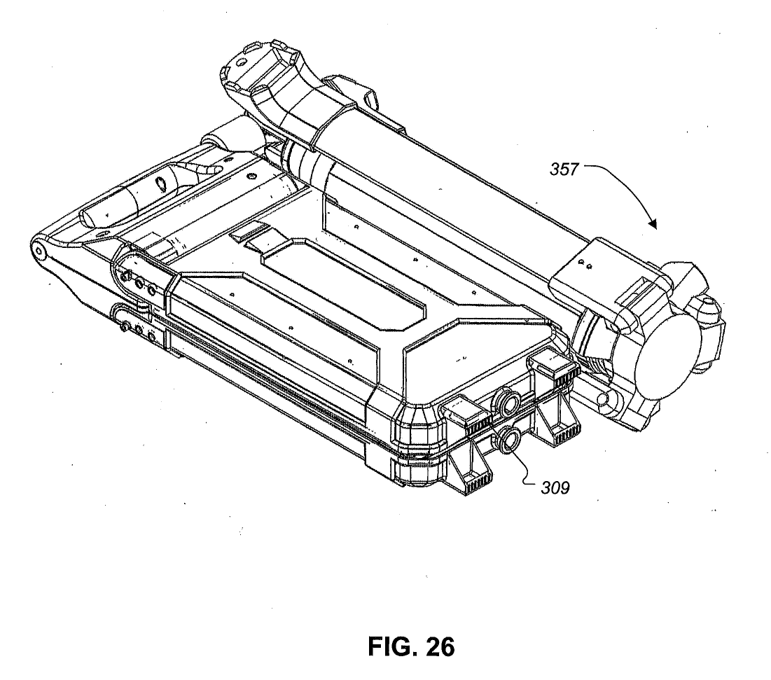

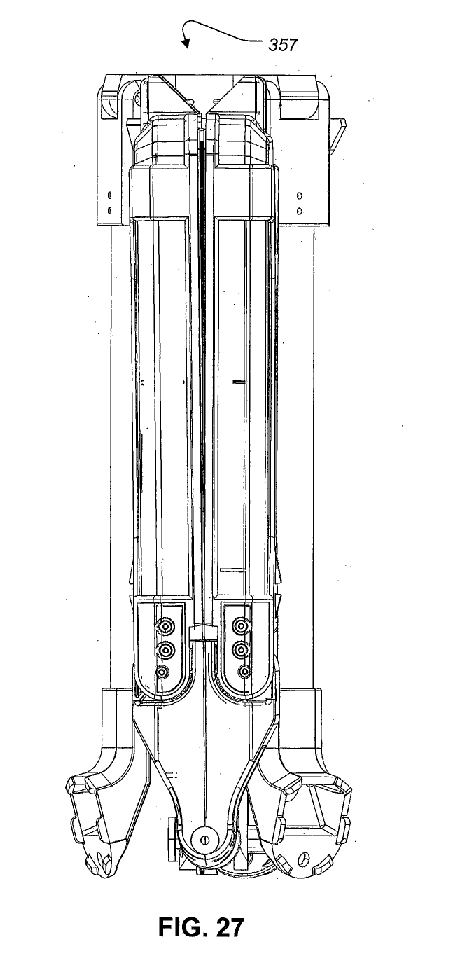

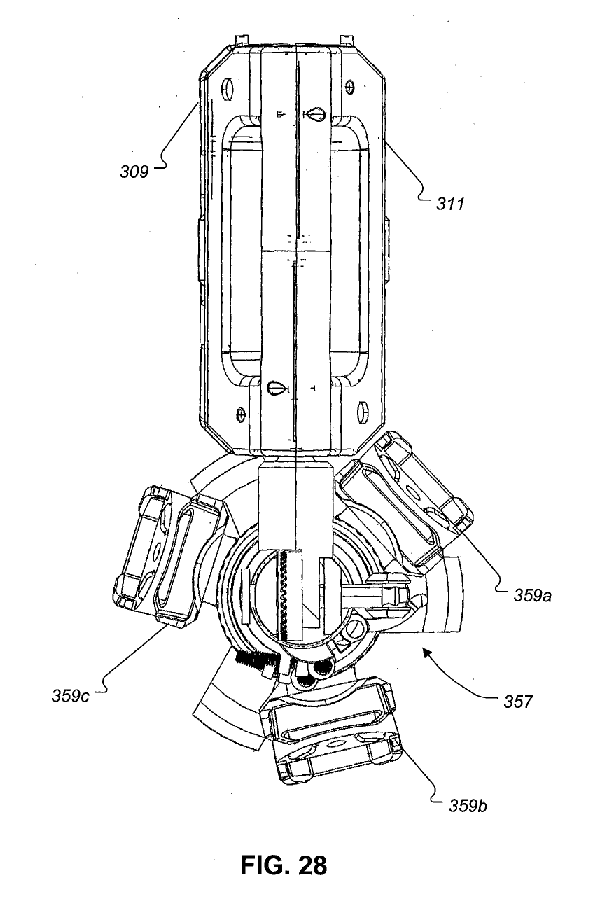

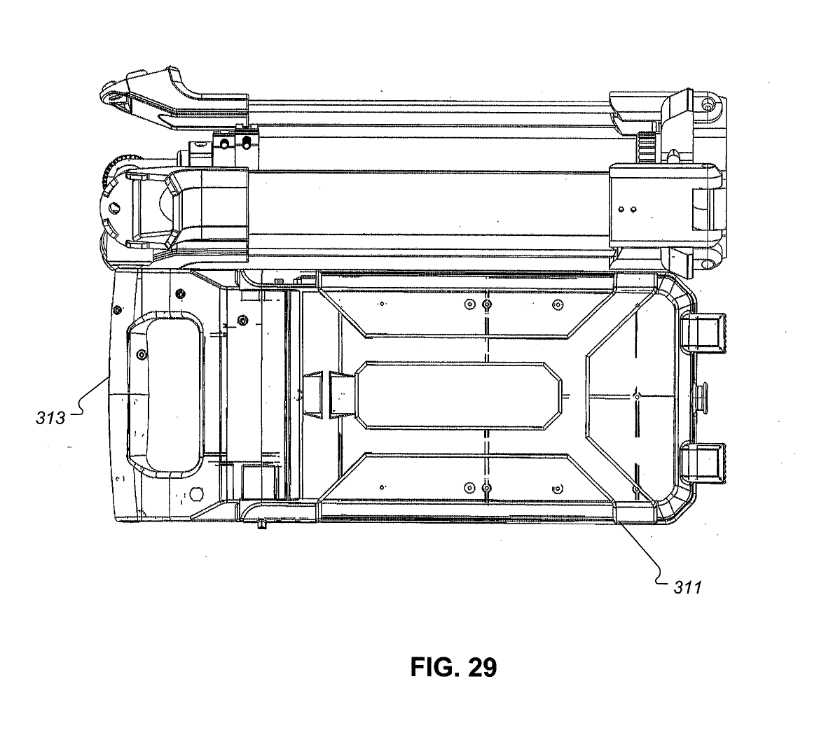

Referring now also to FIGS. 8-16 an embodiment of a worklight assembly 301. FIGS. 8-24 show the worklight assembly 301 in a deployed state, whereas FIGS. 25-29 show the worklight assembly 301 in a collapsed state. The worklight assembly 301 includes a head assembly 303 connected to a multi-legged support assembly 305. In the deployed state, the head assembly 303 is supported by the multi-legged support assembly 305 so that the worklight assembly 301 can be used to illuminate an adjacent area. In the collapsed state, the head assembly 303 and multi-legged support assembly 305 are folded together so that the worklight assembly 301 can easily be transported or stored while not in use.

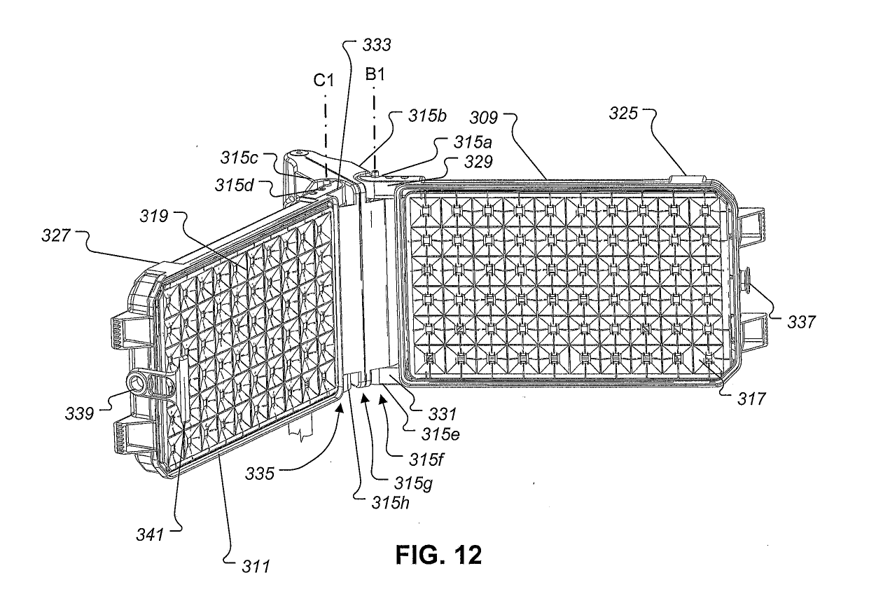

The head assembly 303 includes a first worklight 309 and a second worklight 311. The worklights 309 and 311 are both hingedly connected to a dual-hinged handle 313. The worklights 309 and 311 can be swiveled relative to the handle 313 by means of articulated joints 315a, 315b, 315c, 315d, 315e, 315f, 315g, and 315h. The articulated joints 315a-315h allow the worklights 309 and 311 to move between the deployed configuration shown in FIGS. 8-24, and the collapsed configuration shown in FIGS. 25-29. More specifically, worklight 309 is configured to rotate about a longitudinal axis B1 of the handle 313, and worklight 311 configured to rotate about a longitudinal axis C1 of the handle 313. In the view shown in FIG. 12, the worklights 309 and 311 have been rotated 170 degrees about axis B1 and C1 from the collapsed configuration shown in FIGS. 25-29. In some embodiments, 170 degrees can be the maximum open angle such that the configuration shown in FIG. 12 would be a fully-opened state. However, alternative embodiments can be configured for other maximum angles, including angles greater than and less than 170 degrees, such as 180 degrees.

Worklights 309 and 311 each include a respective one of light panels 317 and 319. In the preferred embodiment, the light panels 317 and 319 each include a plurality of LEDs, however other light sources can be used. The light panels 317 and 319 can be substantially identical to each other, for example both including the same number of LEDs arranged in the same pattern, or the light panels 317 and 319 can differ from each other, for example one having more LEDs than the other. The exact number, arrangement, and types of LEDs can vary. In one embodiment, for example, light panels 317 and 319 can be configured to emit about 6,000 Lumens each so that the light panels 317 and 319 together can emit about 12,000 Lumens. However, alternative embodiments can be configured to emit any of a great variety of different Lumen values. Additionally, a first light panel could be configured for crime scene lighting at a certain wavelength and a second light panel configured for white light with a switch to change the various modes. Also, in some embodiments, the worklights 309 and 311 can include multiple brightness settings. For example, worklights 309 and 311 can include a “HIGH” setting and a “LOW” setting, where more lumens are emitted in the “HIGH” setting than in the “LOW” setting. In one such embodiment, as an example, light panels 317 and 319 can be configured to emit about 6,000 Lumens each in the “HIGH” setting and about 3,000 Lumens each in the “LOW” setting. Light panels can further comprise optical filters and optical screens located entirely or partially across the light panel to diffuse and or polarize the light emitted.

In some embodiments, the worklights 309 and 311 can be configured to be independently turned on and off, for example so that a user can turn on/off only one or both of the worklights 309 and 311 if so desired. For example, in the illustrated embodiment, the worklights 309 and 311 can be controlled to only be turned on and off together, for example from a single power switch. Alternatively, each of the worklights 309 and 311 includes a power switches 321.

The worklights 309 and 311 can be battery-powered, solar-powered, and/or include means for receiving electrical power from an outside power source via a power port 323. For example, one or both of the worklights 309 and 311 can include a power cord. Additionally, worklights 309 and 311 can be remotely controlled through a smartdevice across a network or by a remote control. For example, multiple lights can be utilized with one remote to control lights across an entire accident or jobsite.

The light panels 317 and 319 are supported by respective worklight housings 325 and 327. The worklight housings 325 and 327 are preferably formed of a durable rigid material, such as a plastic or metal material. Typically each worklight housing is made from a mold having the same shape.

The worklight housing 325 includes an upper arm 329 and a lower arm 331 for connecting the worklight housing 325 to the articulated joints 315a and 315e, respectively. The worklight housing 327 includes an upper arm 333 and a lower arm 335 for connecting the worklight housing 327 to the articulated joints 315d and 315h, respectively. The arms 329, 331, 333, and 335 also serve to distance the worklight housings 325 and 327 from the handle 313 so that a user can easily grip the handle 313 when the worklight assembly 301 is in the collapsed configuration. Worklight housing 325 includes a tubular member 337 with a circular lip. Worklight housing 327 includes a tubular member 339 with a circular lip. Latch 341, preferably rubber, has two openings, one opening is smaller to fit closer to the tubular member, both configured to hold the lips of the tubular members closed. Latch 341 also has a handle so that the latch can be pulled over the second tubular member and held under tension by the elastic nature of the latch. Furthermore, the latch can be reversed.

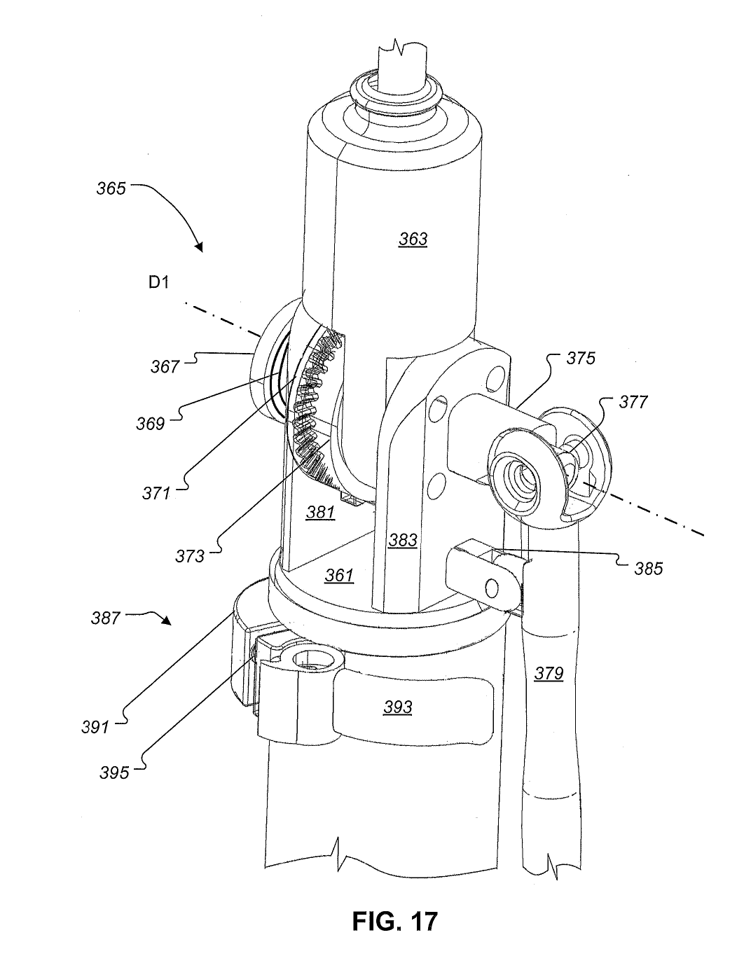

Multi-legged support assembly 305 is comprised of a support head 353, a mast 355, a mast base 357, and support legs 359a-359c. Referring now also to FIGS. 17-19, an embodiment of the support head 353. Support head 353 is comprised of a base 361 pivotally connected to an upper member 363 via a pivot 365. Pivot 365 is configured to allow a user to rotate the upper member 363 relative to the base 361 along an axis Dl.

Pivot 365 is comprised of a pivot end 367, a spring 369, a first gear 371, a second gear 373, a spacer 375, a shaft 377, and a handle 379. Pivot 365 locks into place until handle 379 is squeezed closer to the center of the mast. Squeezing handle 379 releases tension in spring 369 thereby allowing the first gear 371 and the second gear 373 to separate. Separation of the first and second gears allows the upper member 363 to rotate relative to base 361.

Base 361 is comprised of a first tang 381 and a second tang 383. Shaft 377 is hingedly attached to handle 379 at a first end of the shaft and rigidly attached to pivot end 367 opposite the handle. Both pivot end 367 and handle 379 are located outside the tangs of base 361. Spring 369 is located between first tang 381 and pivot end 367, spring 369 pushes the pivot end 367 away from the first tang and pulls the shaft 377 the same direction as the pivot end. Second gear 373 is rigidly attached to upper member 363 and to shaft 377. A fulcrum 385 located between the handle 379 and the second tang 383 provides leverage when the handle is squeezed to compress spring 369 and create a gap between the first gear 371 and the second gear 373. Quick release member 387 is comprised of a split ring 391, a ridged handle 393, and a fastener 395.

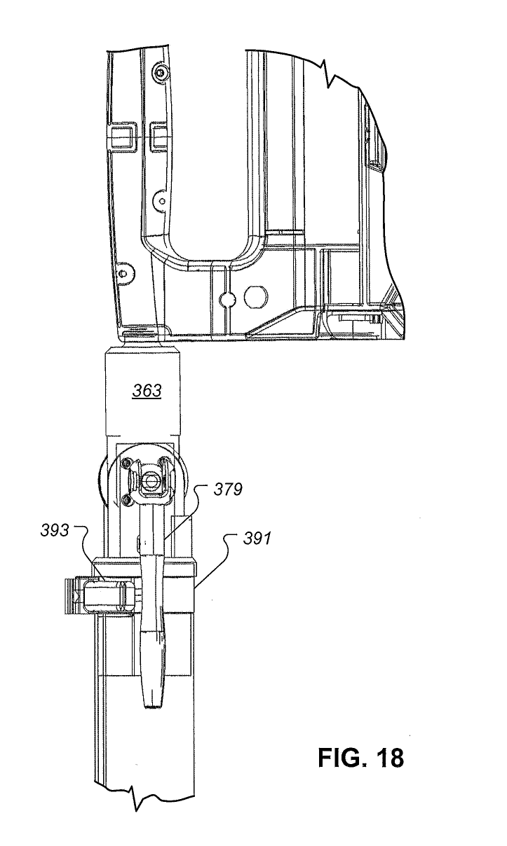

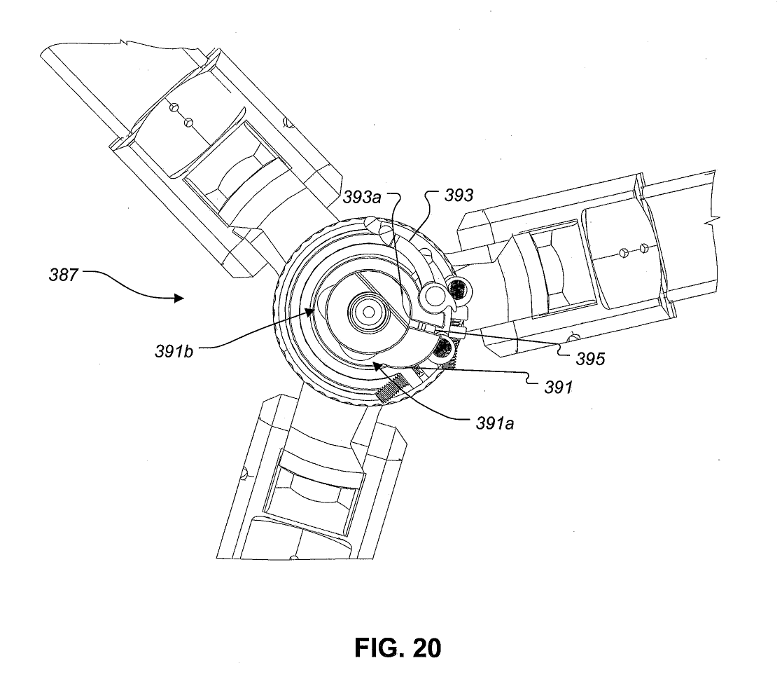

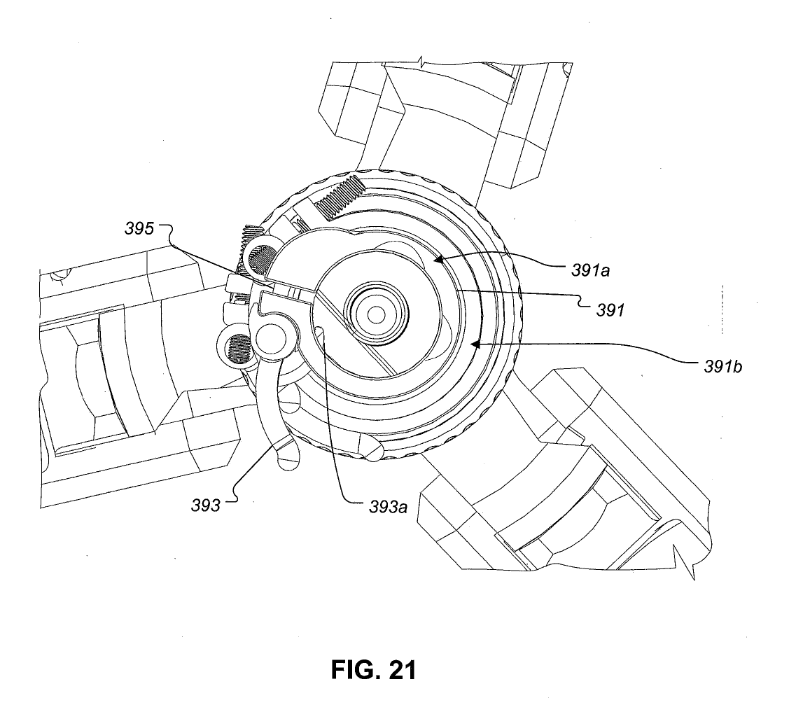

Referring now also to FIGS. 20-21, an embodiment of the quick release member 387. Split ring 391 is comprised of a first notch 391a and a second notch 391b. First notch and second notch are configured to allow the split ring to flex as ridged handle is rotated. Fastener 395 spans a gap in the split ring 391 and couples the ridged handle 393 to a first end of the split ring. As ridged handle 393 rotates around an end of the fastener located near a second end of the split ring 391 a diameter of the split ring 391 is adjusted. FIG. 18A illustrates ridged handle in a first position wherein a ridged portion 393a of the ridged handle protrudes into a central shaft of the multi-legged support. Ridged portion 393a of the ridged handle frictionally engages an annular groove of base 361. In the first position the ridged portion 393a applies friction to the groove of base 361 and prevents the base from rotating and prevents the base from being removed from the multi-legged support. In the second position the ridged portion 393a is partially located in the groove of base 361 and prevents the base from being removed from the multi-legged support. In the third position the ridged portion 393a is not located in the groove of base 361 and does not prevent the base from being removed from the multi-legged support as the gap in the split ring is larger.

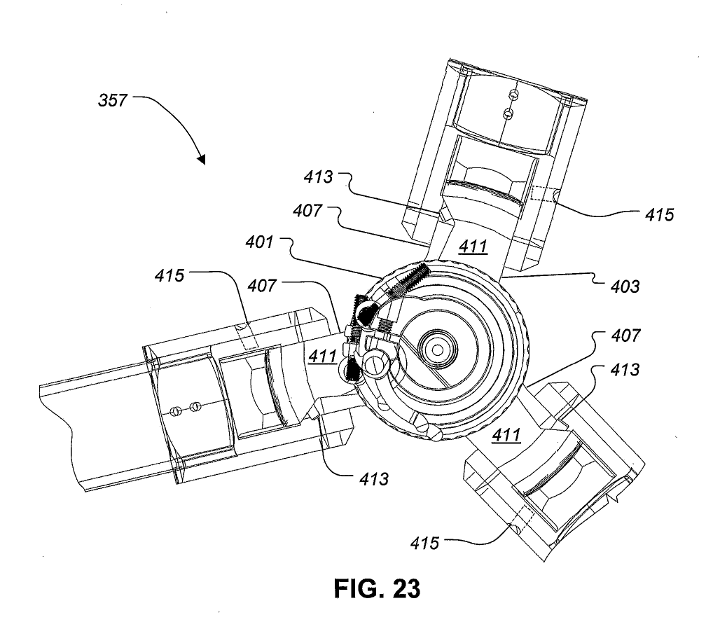

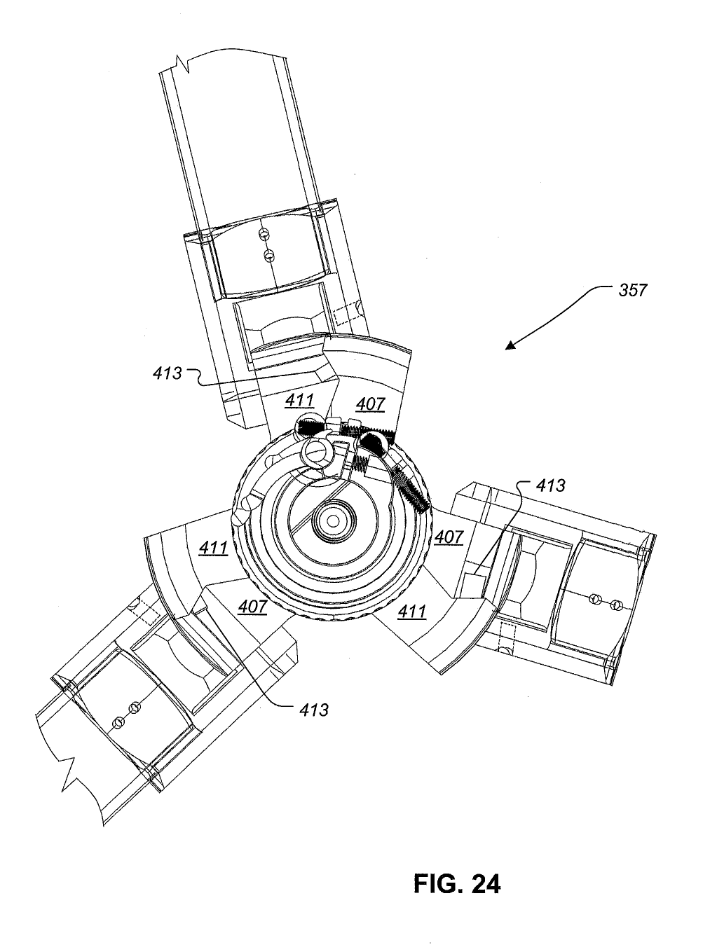

Referring now also to FIGS. 23-24, an embodiment of the mast base 357. Mast base 357 is comprised of a non-rotating member 401 and a rotating member 403. Non-rotating member 401 is comprised of a circular member 405 having a plurality of clevis arms 407 extending outwardly from the circular member. Circular member is coupled to the mast 355. Support legs 359a-359c are pivotally attached to clevis arms 407 of the circular member 405. Support legs 359a-359c in a first position are spread out to support the worklight assembly and in a second position are rotated nearly parallel the mast to be compact. Rotating member 403 rotates along an axis located at a center of the mast. Rotating member 403 is comprised of a plurality of radially extending member 411. Radially extending members 411 include a post 413 located on a trailing edge of the radially extending member. Rotating member 403 is biased in relation to the non-rotating member 401 by a spring. A resting position for the rotating member is shown in FIG. 23 where a central axis of the radially extending members 411 is proximate a central axis of the clevis arms 407. In the resting position for the rotating member the spring is relaxed and the radially extending members prevent the support legs from rotating into the compact position. FIG. 24 illustrates a mid-position of the rotating member as the spring has some tension and the support legs still cannot be rotated upwards. In a collapsed configuration, post 413 is retained by opening 415 located on support leg. The system is configured such support leg is rotated up held in position by post 413 in opening 415. To lower the support leg, the rotating member is rotated around the mast, such that the post is no longer in the opening, then the leg is lowered, and the spring pulls the rotating member to a resting position.

Referring now also to FIGS. 25-29 an embodiment of a worklight assembly 301. FIGS. 25-29 show the worklight assembly 301 in a collapsed state. Worklight assembly in the collapsed state is folded up compactly and can be stored in a trunk or on a shelf.

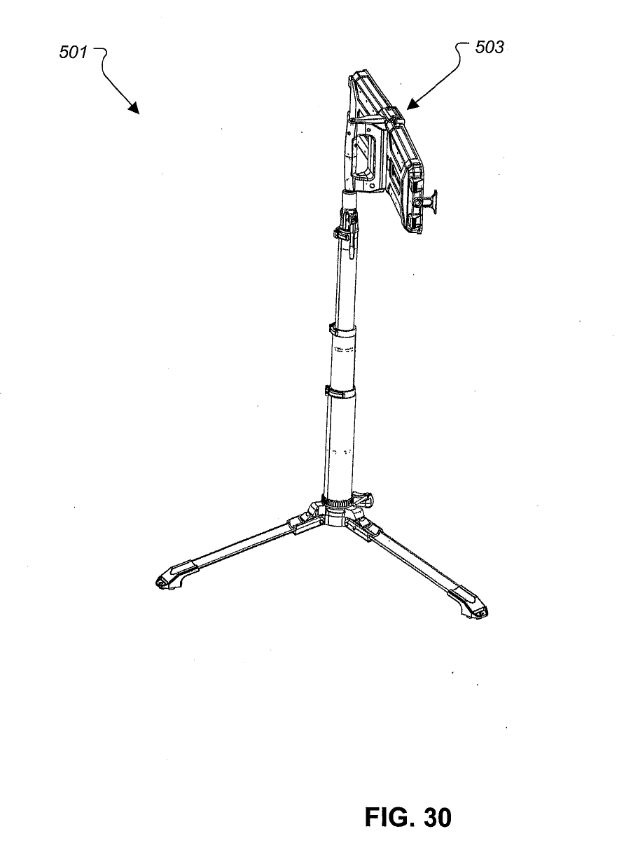

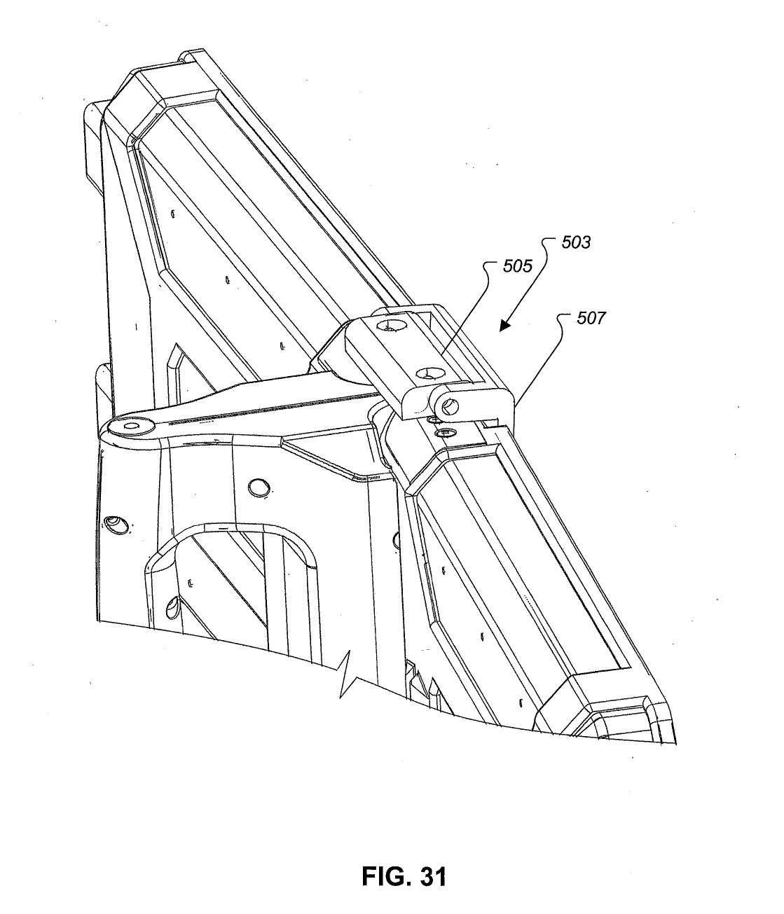

Referring now also to FIGS. 30-31 an alternative embodiment of a worklight assembly 501. Worklight assembly 501 is comprised of the same elements in worklight assembly 301. However, worklight assembly 501 further comprises a locking mechanism 503. Locking member 503 is comprised of base member 505 and a rotating member 507. Base member 505 is attached to light panel fasteners located along the axis B1 and C1 of rotation for the light panels. Rotating member 507 has an L-shapes profile and pivots around base member 505. Rotating member 507 prevents the light panels from closing and therefore holds the light panels open approximately 180 degrees from each other.

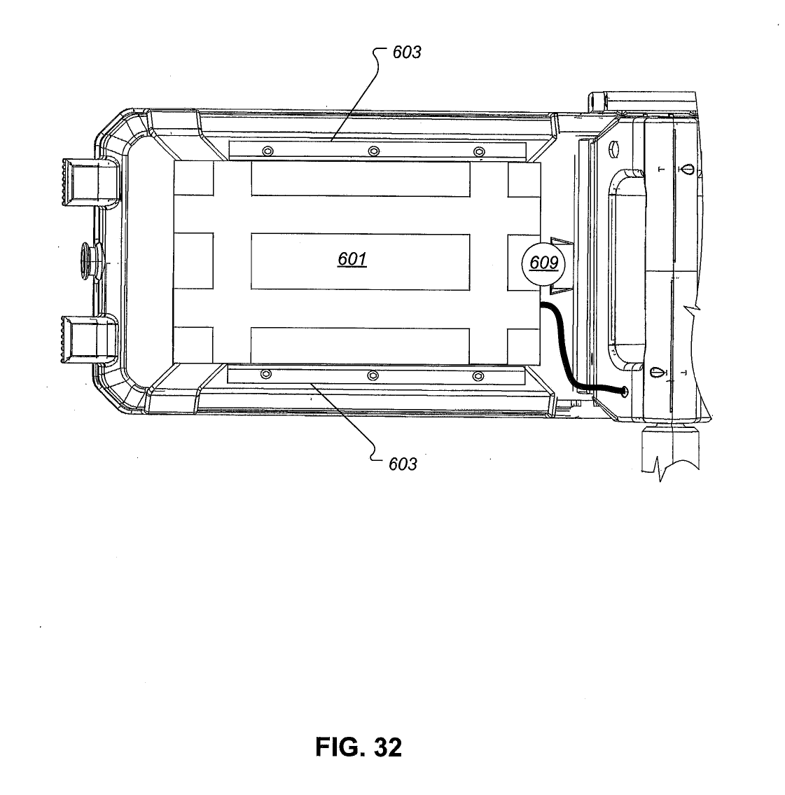

Referring now also to FIG. 32 an embodiment of a battery for a worklight assembly is illustrated. Battery 601 is retained by channels 603 and 605 and battery stop 607. Channels 603 and 605 are removably located on a back surface of the light panels. Battery stop 607 is comprised of a spring held pin 609 and a groove in the back surface of the light panels. Battery 601 is slid into the channels until the pin 609 is retained by the grooves. The pin retained by the grooves prevents the battery from translating along the channels until the user pulls the pin away from the light panels and slidingly removes the battery. The user plugs the cord from the battery into a receptacle located on the handle to battery power the light assembly.

It is apparent that a system with significant advantages has been described and illustrated. The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A worklight comprising:
a head assembly, having;
a first light panel;
a second light panel; and
a dual hinged handle; and
a support assembly, having;
a head for supporting the dual hinged handle;
a mast; and
a multi-legged base;
wherein the first light panel and the second light panel are hinged to the dual hinged handle;
wherein the head is pivotally attached to the mast; and
wherein the worklight is configured to be folded.
